(19) United States
(12) Patent Application Publication
(10) Pub. No.: US 2026/0366698 A1
(43) Pub. Date: Nov. 19, 2026

(54) CASSEGRAIN REFLECTOR LIGHTING DEVICE WITH IMPROVED SCENIC EFFECTS AND STAGE LIGHT FIXTURE COMPRISING SAID LIGHTING DEVICE

(71) Applicant: CLAY PAKY S.R.L., SERIATE (IT)

(72) Inventors: Aris QUADRI, SERIATE (IT); Davide FERRATI, SERIATE (IT); Renato FRISON, SERIATE (IT)

(21) Appl. No.: 19/678,253

(22) Filed: May 15, 2026

(30) Foreign Application Priority Data
May 19, 2025 (IT) 102025000011206

(51) Int. Cl. F21V 7/00; F21V 3/04; F21V 14/00; F21W 131/406

(52) U.S. Cl. CPC F21V 7/0008; F21V 3/049; F21V 14/00; F21W 2131/406

(57) ABSTRACT

A lighting device (1) includes: a primary light source group (3), configured to emit a primary light beam; a light guide (4), extending along a longitudinal axis (A) and coupled to the primary light source group (3) so as to define a defined optical path for at least a part of the primary light beam; a primary reflector (5), arranged along the axis (A) facing the primary light source group (3), to reflect the primary light beam output from the light guide (4); and a secondary reflector (6), arranged facing the primary reflector (5), to reflect the primary light beam reflected by the primary reflector (5) towards an emission area surrounding the primary reflector (5). The primary reflector (5) comprises a convex first mirror (14) and the secondary reflector (6) comprises a concave second mirror (17). Moreover, the secondary reflector (6) is provided with a central aperture (16) engaged, in use, by the light guide (4).

### CROSS-REFERENCE TO RELATED APPLICATIONS

This patent application claims priority from Italian patent application no. 102025000011206 filed on May 19, 2025, the entire disclosure of which is incorporated herein by reference.

### FIELD OF THE INVENTION

The present invention relates to a Cassegrain reflector lighting device with improved scenic effects and a stage light fixture comprising said lighting device.

### BACKGROUND OF THE INVENTION

In the field of stage and entertainment lighting, the need to implement innovative and surprising scenic effects is increasingly felt. Moreover, in recent years, most of the efforts have focused on the field of multi-source light fixtures, preferably LED-based. Such light fixtures are used to create scenic effects with light effects produced, for example, by modifying the shape, orientation, intensity and colour of the light beams. More generally, optical systems for conditioning light beams are adopted in light fixtures in order to modify the propagation characteristics of the light beams emitted by the sources.

Current optical conditioning systems are typically united by the fact that they require heavy and bulky mechano-optical elements which make the manoeuvrability and installation of light fixtures more difficult and which contribute to considerably increasing their production cost. For example, to meet the needs for scenic effects provided by an annular illumination with variable projection angles, known optical conditioning systems employ optical masks (such as, for example, diaphragms) and/or special optics (such as, for example, axicon lenses and/or diffractive systems), which however may have disadvantages such as the reduction of emission efficiency and the increase in complexity and costs. To meet instead the needs for scenic effects provided by a diffusive projection, known optical conditioning systems employ digital diffusive filters with electronic management and/or fixed diffusive filters or filters applied manually by an operator, which however may have disadvantages such as high costs, being bulk and the impossibility of on-site customisation.

### SUMMARY OF THE INVENTION

It is therefore an object of the present invention to overcome or at least in part mitigate the disadvantages and limitations of the state of the art.

According to the present invention, there is provided a Cassegrain reflector lighting device and a light fixture comprising said lighting device as defined in the appended claims.

### BRIEF DESCRIPTION OF THE FIGURES

For a better understanding of the present invention, there are presented preferred embodiments, by way of non-limiting example, with reference to the accompanying drawings, in which:

FIG. 1 schematically shows, in a cross-sectional view, the lighting device according to an embodiment of the present invention;

FIG. 2 schematically shows, in a plan view, a portion of the lighting device of FIG. 1;

FIG. 3 is a schematic representation of the scenic effect obtainable with the lighting device of FIG. 1;

FIG. 4 schematically shows, in a cross-sectional view, the lighting device according to another embodiment of the present invention;

FIG. 5 schematically shows, in a plan view, a portion of the lighting device of FIG. 4 and the scenic effect obtainable with the lighting device of FIG. 4;

FIGS. 6A-6C schematically show, in the same cross-sectional view, the lighting device according to a further embodiment of the present invention and respectively in three distinct operating modes;

FIG. 7 schematically shows, in a cross-sectional view, an enlarged portion of the lighting device of FIGS. 6A-6C; and

FIG. 8 schematically shows, in a plan view, a detail of the portion shown in FIG. 7.

### DESCRIPTION OF EMBODIMENTS

The following description refers to the arrangement shown in the drawings of the figures; consequently, expressions such as “above”, “below”, “upper”, “lower”, “top”, “bottom”, “right”, “left” and the like relate to the attached figures and are not to be construed as limiting.

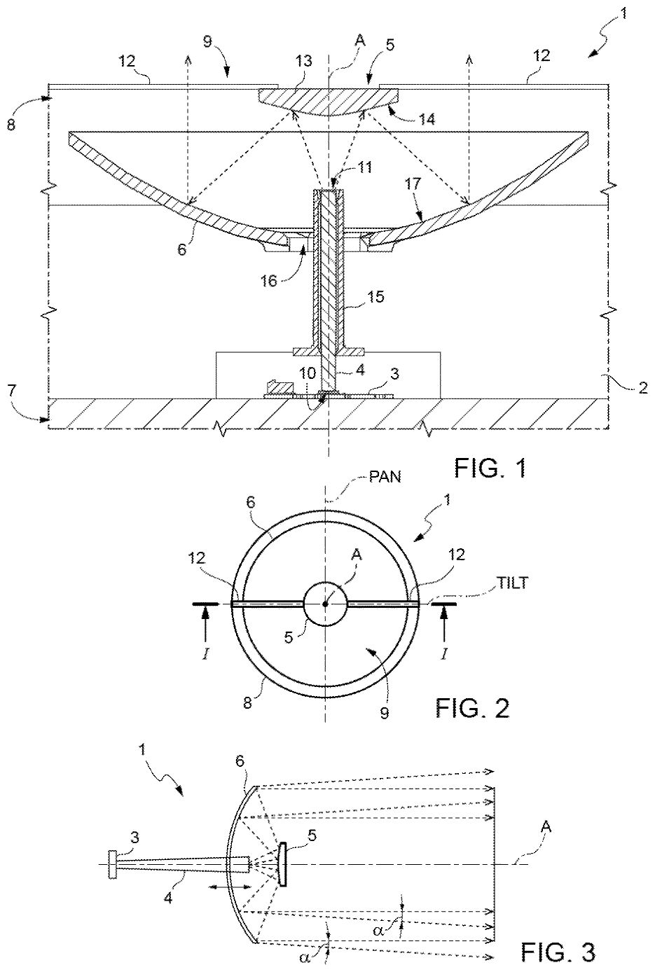

FIG. 1 shows a lighting device 1 according to an embodiment of the present invention and comprising a housing 2, a primary light source group 3 coupled to the housing 2, a light guide 4 coupled to the primary light source group 3, a primary reflector 5 arranged facing the primary light source group 3, and a secondary reflector 6 arranged facing the primary reflector 5.

The housing 2 extends along a longitudinal axis A and is provided with a first closed end 7 and a second end 8, opposite the first end 7 along the axis A and provided with a projection outlet 9 which defines, as explained in more detail below, the emission area of the generated light beam. For example, the projection outlet 9 has a substantially circular cross-section. Moreover, at the second end 8, the housing 2 is provided with a closure element (not shown in the accompanying figures), preferably with a shape complementary to the projection outlet 9 and fixed perimetrically to the body of the housing 2. For example, the closure element is transparent to light radiation and has no particular optical properties; in a variant, the closure element may comprise one or more optical elements for conditioning the outgoing light beam.

In a non-limiting embodiment, the lighting device 1 is for example part of a stage light fixture comprising mechatronic systems for moving the lighting device 1 in order to create multiple scenic effects. For example, the housing 2 of the lighting device 1 is rotatably supported by a pair of parallel arms of the light fixture (for example, substantially forming a yoke) and by a base of the light fixture: the rotatable coupling with the arms allows for rotation around a TILT axis, while the rotatable coupling with the base allows for rotation around a PAN axis, the TILT axis and the PAN axis being perpendicular to each other and perpendicular to the axis A (see FIG. 2). In a further embodiment, the stage light fixture comprises a plurality of lighting devices like the lighting device 1, for example arranged aligned along the TILT axis.

With reference again to FIG. 1, the primary light source group 3 is housed in the housing 2, being fixed thereto, and is configured to generate and emit a primary light beam. Preferably, the primary light source group 3 is configured to generate light radiation of different colours. In the non-limiting example described and illustrated herein, the primary light source group 3 comprises a plurality of light sources (not visible in the accompanying figures), arranged side by side on a planar support. For example, there are four light sources and they are RGBW (Red Green Blue White) sources; the light sources may be of the LED type or may comprise laser diodes of different colours.

The light guide 4 extends substantially along the axis A and is coupled to the primary light source group 3 so as to collect the primary light beam emitted by the primary light source group 3 and so as to define a defined optical path for at least a part of the primary light beam. In detail, the light guide 4 is an optical mixing tube provided with an input 10 and an output 11. The input 10 is coupled to the primary light source group 3 and the output 11 faces the primary reflector 5. In a non-limiting embodiment, the light guide 4 is provided with reflecting internal walls (the light guide 4 is known in this case as a “light tunnel”). In an alternative embodiment, the light guide 4 is a plastic or glass rod.

In a non-limiting embodiment, the light guide 4 has a substantially hexagonal cross-section. Preferably, the light guide 4 has an increasing cross-section starting from the input 10 up to the output 11. The degree of tapering of the optical tube is defined so as to determine a primary light beam exiting the output 11 of the light guide 4 which impinges on the primary reflector 5 minimising the loss of light radiation.

Preferably, the input 10 of the light guide 4 is shaped to collect as many light rays of the primary light beam as possible. In particular, the input 10 defines an inlet passage having an area at least equal to the area of the emission surface defined by the light sources of the primary light source group 3. More particularly, the area of the inlet passage is greater than the area of the emission surface defined by the light sources. Preferably, the input 10 is shaped to substantially surround the light sources. The output 11 is preferably provided with a closure element transparent to light radiation. According to variants not illustrated, the output 11 may be open or provided with a phosphor converter.

The light guide 4 is supported by a tubular element 15, configured to house the light guide 4 and extending along the axis A. The tubular element 15 is a hollow body provided with a through channel, in which the light guide 4 is at least partially housed. The through channel of the tubular element 15 preferably has a shape complementary to the shape of the light guide 4. The tubular element 15 can be fixed to a support structure integral with the housing 2.

With reference also to FIG. 2, the primary reflector 5 is arranged along the axis A facing the primary light source group 3 to reflect the primary light beam exiting the light guide 4. In detail, the primary reflector 5 is supported by the housing 2 in such a way that the output 11 of the light guide 4 is disposed at a distance from the primary reflector 5. In a non-limiting embodiment, the housing 2 comprises uprights 12 which extend transversely to the axis A and substantially facing the source group 3, to support the primary reflector 5. In an alternative embodiment, the uprights 12 are absent and the primary reflector 5 is coupled directly to the closure element of the housing 2.

The primary reflector 5 comprises in detail a support body 13 and a convex first mirror 14 coupled to the support body 13. The support body 13 is coupled to the uprights 12 (or directly to the closure element) of the housing 2 and is shaped to support the first mirror 14 so that the first mirror 14 is directed towards the primary light source group 3. In detail, the support body 13 comprises a face directed towards the primary light source group 3 and coupled to the first mirror 14, and an outer edge that surrounds said face. More in detail, the support body 13 substantially has the same transverse dimension as the first mirror 14. In a non-limiting embodiment, the first mirror 14 is defined by a convex primary reflection surface of the support body 13 facing the light guide 4 and with an axially-symmetrical shape. Moreover, the first mirror 14 has for example a substantially circular perimeter (see FIG. 2) or elliptical.

The secondary reflector 6 is arranged facing the primary reflector 5, to reflect the primary light beam reflected by the primary reflector 5 towards an emission area surrounding the primary reflector 5 itself. In other words, the emission area of the lighting device 1 extends around the primary reflector 5. Specifically, the primary reflector 5 and the secondary reflector 6 form a Cassegrain-type reflector for the primary light beam.

The secondary reflector 6 is arranged around the axis A. In detail, the secondary reflector 6 is provided with a central aperture 16, substantially centred on the axis A, so that it can be arranged around the light guide 4. In other words, the light guide 4, and therefore the tubular element 15, are housed in, i.e. engage, the central aperture 16 of the secondary reflector 6.

The secondary reflector 6 comprises in detail a concave second mirror 17. The second mirror 17 is provided with a secondary reflection surface facing the projection outlet 9 of the lighting device 1. In a non-limiting embodiment, the secondary reflection surface has an axially-symmetrical shape. For example, the second mirror 17 has a substantially circular (see FIG. 2), elliptical or rectangular perimeter.

With particular reference to FIG. 3, according to one aspect of the present invention, at least one of the light guide 4, the primary reflector 5 and the secondary reflector 6 is movable inside the housing 2 in order to vary the angular distribution of the primary light beam reflected by the secondary reflector 6, i.e. to vary an output angle α—with respect to the axis A—of the primary light beam from the lighting device 1. In detail, the movement of one or more of said elements allows switching from a condition of substantial collimation of the primary light beam exiting the lighting device 1 (for example, α≤1°) to conditions of an increase in the output angle α, up to for example a maximum of α substantially equal to 20°, and therefore of divergence of the primary light beam.

In a non-limiting embodiment, the light guide 4 and/or the secondary reflector 6 is movable, along the axis A, with respect to the primary reflector 5. In an alternative embodiment, the primary reflector 5 is movable, along the axis A, with respect to the light guide 4 and the secondary reflector 6.

The lighting device 1 therefore makes it possible to obtain the scenic effect of an annular illumination with variable projection angles, adapting to multiple applications without the use of additional components. In particular, the lighting device 1 makes it possible to control the divergence of the light beams exiting from it in a simple manner, containing costs and overall dimensions and without introducing losses of light efficiency and chromatic aberrations.

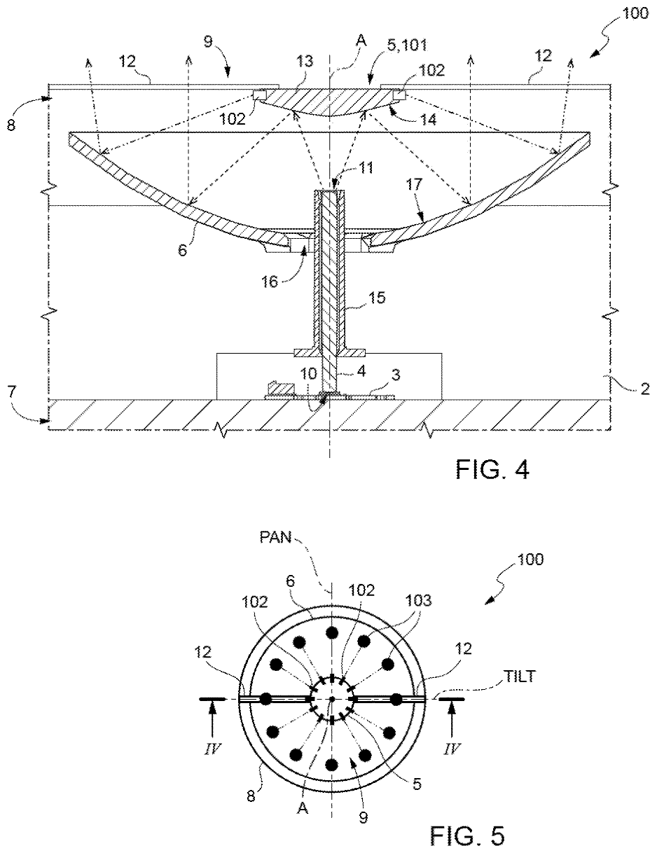

Referring now to FIG. 4 and FIG. 5, a variant of the lighting device 1 of FIGS. 1-3 is described, hereinafter referred to as lighting device 100. In particular, the lighting device 100 is described with reference only to the differences with respect to the lighting device 1 of FIGS. 1-3. Moreover, elements of the lighting device 100 that correspond to elements of the lighting device 1 of FIGS. 1-3 are indicated with the same reference numerals.

The lighting device 100 comprises, in addition to the primary light source group 3, a secondary light source group 101, configured to generate and emit at least one secondary light beam. According to one aspect of the present invention, the secondary light source group 101 is integrated into the primary reflector 5 and is arranged so as that at least a part of the at least one secondary light beam emitted is reflected by the secondary reflector 6, as shown in FIG. 4.

In detail, the secondary light source group 101 is supported by the support body 13 of the primary reflector 5. More in detail, the secondary light source group 101 is arranged along the outer edge of the support body 13. The power supply and control signals for the secondary light source group 101 can be provided, for example, by means of cables extending along the uprights 12.

The lighting device 100 further comprises a control device (not shown in the accompanying figures) configured to independently control the primary light source group 3 and the secondary light source group 101. For example, the control device is a control console or a control and processing unit of the stage light fixture in which the lighting device 100 is integrated. In detail, the primary light source group 3 and the secondary light source group 101 of the lighting device 100 can be controlled to emit the primary light beam and the secondary light beam independently, respectively. In a non-limiting embodiment, the primary light beam and the secondary light beam have different emission spectra and/or are emitted with different intensities.

The secondary light source group 101 comprises in detail a plurality of secondary light sources 102 (twelve shown for example in FIG. 5). Each secondary light source 102 is configured to generate and emit a respective secondary light beam. Preferably, the secondary light sources 102 are arranged aligned along a substantially circular path around the first mirror 14. Each secondary light source 102 is for example supported by the support body 13 so as to protrude from it towards the secondary reflector 6. More generally, the secondary light sources 102 are arranged along the perimeter of the primary reflector 5.

In a non-limiting embodiment, the secondary light sources 102 are arranged equidistant from each other, for example the secondary light sources 102 are arranged with axial symmetry with respect to the centre of the primary reflector 5. The secondary light sources 102 can be integrated into the primary reflector 5 or they can be applied to it. In an alternative embodiment, the secondary light sources 102 are arranged contiguously to each other (for example, the secondary light sources 102 are adhered to each other); in such an alternative embodiment, a diffusive light guide can be applied on the secondary light sources 102 so as to generate a substantially continuous secondary light beam.

More in detail, each secondary light source 102 is oriented so as to emit at least a part of a respective secondary light beam towards the secondary reflector 6. Like the primary light beam, the secondary light beams are also therefore reflected by the secondary reflector 6 towards the emission area surrounding the primary reflector 5. The secondary light beams are thus superimposed, on exit from the lighting device 100, on the primary light beam. In a non-limiting embodiment, each secondary light source 102 comprises for example respective conditioning optics so as to emit a respective substantially collimated secondary light beam, or in any case with a contained divergence. In an alternative embodiment, divergent secondary light beams instead only partially intercept the secondary reflector 6.

Preferably, the secondary light sources 102 have respective emission outlets that—parallel to the axis A—are more distal from the secondary reflector 6 than the first mirror 14. More generally, the secondary light sources 102 are arranged so as not to interfere with the optical paths of the primary light beam from the light guide 4 to the projection outlet 9 of the lighting device 100.

The secondary light sources 102 may for example be of the LED type or may comprise laser diodes of the same colour. In addition, the secondary light sources 102 can be divided into groups of sources that emit different colours.

With particular reference to FIG. 5, the secondary light beam emitted by the secondary light source group 101, when it impinges on the secondary reflector 6, produces on it a plurality of footprints 103, for example substantially circular or elliptical. Each footprint 103 is for example associated with a respective secondary light source 102 of the secondary light source group 101. These footprints 103 are visible to an external observer looking towards the lighting device 100. Moreover, the footprints 103 are, from a visual point of view, contained within the emission area of the lighting device 100 defined by the primary light beam. In an alternative embodiment (not shown) the secondary light beam emitted by the secondary light source group 101 produces a single, substantially continuous, annular-shaped footprint on the secondary reflector 6.

The lighting device 100 therefore makes it possible to obtain the innovative scenic effect of a luminous corona (or luminous ring) visible on the secondary reflector 6, for example of a different colour from the colour of the primary light beam exiting the lighting device 100 (similar to that exiting the lighting device 1 of FIGS. 1-3). In particular, such a scenic effect can be superimposed on other scenic effects achievable with a Cassegrain reflector lighting device, such as the lighting device 1 of FIGS. 1-3.

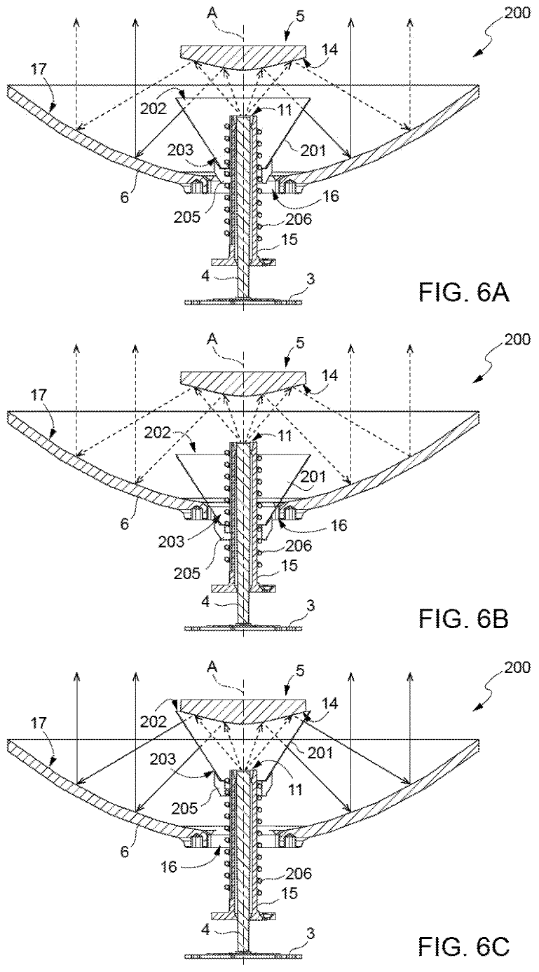

Referring now to FIGS. 6A-6C, FIG. 7 and FIG. 8, a variant of the lighting device 1 of FIGS. 1-3 and of the lighting device 100 of FIGS. 4 and 5 is described, hereinafter referred to as lighting device 200. In particular, the lighting device 200 is described with reference only to the differences with respect to the lighting device 1 of FIGS. 1-3. Moreover, elements of the lighting device 200 that correspond to elements of the lighting device 1 of FIGS. 1-3 are indicated with the same reference numerals.

With particular reference to FIGS. 6A-6C (which for simplicity show only the components of interest from an optical point of view), the lighting device 200 comprises, in addition to what is shown in FIGS. 1-3, a diffuser 201 of a substantially truncated-cone shape. In detail, the diffuser 201 is optically interposed between the primary reflector 5 and the secondary reflector 6. Moreover, the diffuser 201 is arranged and extends along the axis A, i.e. its axis is parallel to the axis A. More in detail, the diffuser 201 comprises a larger cross-section end 202, facing the primary reflector 5, and a smaller cross-section end 203, opposite the larger cross-section end 202 along the axis A and facing the primary light source group 3.

According to one aspect of the present invention, the diffuser 201 is shaped so as to be placed around the light guide 4. In a non-limiting embodiment, the diffuser 201 is defined solely by a truncated conical lateral surface, i.e. the diffuser 201 is internally hollow, with the larger cross-section end 202 and the smaller cross-section end 203 open. In other words, in such an embodiment, the diffuser 201 has a shape that resembles a funnel.

The diffuser 201 may comprise a body transparent to light radiation on whose internal and/or external walls one or more layers of diffusive material are applied, such as for example films of diffusive opaline plastic material. Alternatively, the diffuser 201 is entirely a diffusive body substantially made of plastic material or glass. The diffuser 201 is in general a diffusive filter.

The diffuser 201 is movable to selectively apply a diffusive action to the primary light beam that is reflected by the primary reflector 5. In detail, the light rays of the primary light beam reflected by the first mirror 14 encounter, on their path towards the secondary reflector 6, respective portions of the diffuser 201, being thus diffused (as represented by the solid lines of the arrows in FIGS. 6A-6C).

According to a further aspect of the present invention, the diffuser 201 is configured to be moved, with respect to the light guide 4 and along the axis A, between a first operating position (FIG. 6B), in which the diffusive action is minimal, and a second operating position (FIG. 6C), in which the diffusive action is maximum. In detail, in the lighting device 200 the diffuser 201 can be inserted or disengaged from the optical path of the primary light beam (between the primary reflector 5 and the secondary reflector 6) in an adjustable manner, as described below. FIG. 6A shows, for example, an intermediate operating position between the first operating position and the second operating position, for example with a diffusive action of the diffuser 201 on the primary light beam equal to 50%.

In the first operating position (FIG. 6B), the diffuser 201 is completely retracted with respect to the output 11 of the light guide 4, i.e. the larger cross-section end 202 is at a greater distance from the first mirror 14 than the output 11 of the light guide 4. The diffuser 201 is therefore completely disengaged from the optical path between the primary reflector 5 and the secondary reflector 6. In this way, the light rays are reflected by the first mirror 14 substantially unperturbed, i.e. without passing through portions of the diffuser 201. Preferably, therefore, the minimum diffusive action is substantially null. The first operating position defines, for example, an end stop for the movement of the diffuser 201 along the axis A.

In the second operating position (FIG. 6C), the diffuser 201 is completely inserted in the optical path between the primary reflector 5 and the secondary reflector 6. The larger cross-section end 202 is in proximity to the first mirror 14, while the smaller cross-section end 203 is instead in proximity to the output 11 of the light guide 4, for example it is flush with it. In this way, substantially all the light rays reflected by the first mirror 14, i.e. substantially all the light rays exiting the light guide 4, pass through the diffuser 201. Preferably, therefore, the maximum diffusive action is almost total (i.e., at 100%) for the primary light beam. The second operating position defines, for example, an end stop for the movement of the diffuser 201 along the axis A.

In other words, in the first operating position the larger cross-section end 202 of the diffuser 201 is distal from the primary reflector 5, while in the second operating position the larger cross-section end 202 of the diffuser 201 is proximal to the primary reflector 5.

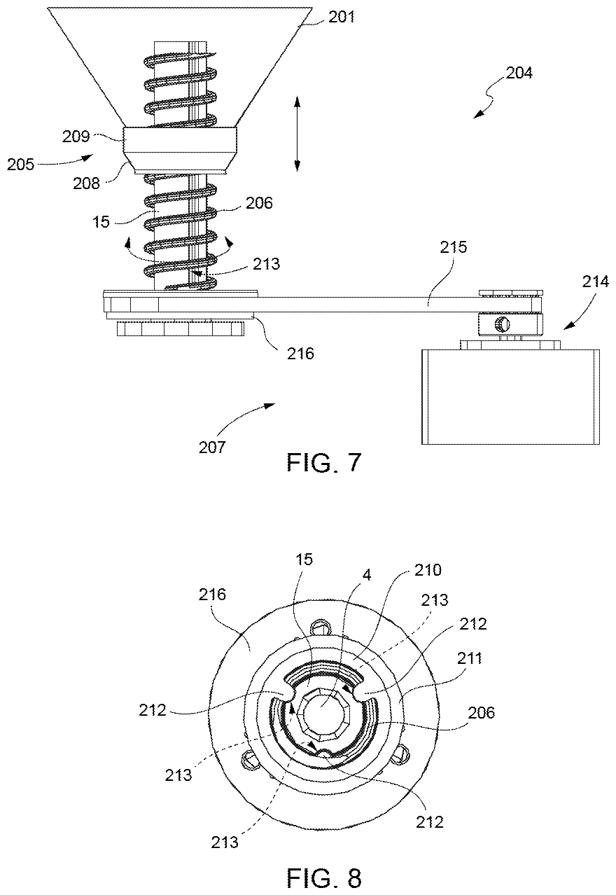

With reference also to FIG. 7 and FIG. 8, the lighting device 200 comprises a drive mechanism 204 of the diffuser 201, configured to move the diffuser 201 along the axis A between the first operating position and the second operating position. In detail, the drive mechanism 204 is configured to cause the diffuser 201 to translate along the axis A.

Preferably, the drive mechanism 204 is of the endless screw type and is configured so as to prevent the rotation of the diffuser 201 during the movement along the axis A.

The drive mechanism 204 comprises in detail: the tubular element 15 supporting the light guide 4; a support element 205, coupled to the diffuser 201 and configured to be movable (along the axis A) with respect to the tubular element 15; a helicoidal element (or, helicoid) 206, cooperating with the support element 205 and extending along the axis A around the tubular element 15; and an actuator 207, configured to rotate the helicoidal element 206. More in detail, the helicoidal element 206 cooperates with the support element 205 so that rotations of the helicoidal element 206 around the axis A correspond to translations of the support element 205 along the axis A, thus allowing the movement of the diffuser 201 between the first operating position and the second operating position.

The support element 205 is shaped to surround the light guide 4 and, in particular, the tubular element 15, with respect to which it can translate. The support element 205 comprises in detail a sliding portion 208 and a coupling portion 209, which surmounts the sliding portion 208. The sliding portion 208 and the coupling portion 209 form for example a single body. The support element 205 has a substantially annular shape; the support element 205 has thus two ends, opposite to each other along the axis A, which are open.

The coupling portion 209 receives and supports the diffuser 201, i.e. acts as a filter holder. The coupling portion 209 comprises in detail a support ring 210, for example flat, and a lateral ring 211, connected to the support ring 210 and having for example oblique internal walls. The smaller cross-section end 203 of the diffuser 201 is coupled to the support ring 210 and to the lateral ring 211, for example it is glued to them.

The sliding portion 208 comprises in detail protrusions 212, extending from internal walls of the sliding portion 208 towards the light guide 4. The protrusions 212 are arranged offset parallel to the axis A, i.e. axially offset, so as to cooperate with the windings of the helicoidal element 206. Preferably, there are three protrusions 212 and they are arranged at 120° to each other. More generally, there are at least two protrusions 212.

The protrusions 212 of the sliding portion 208 engage corresponding axial grooves 213 of the tubular element 15 of the light guide 4 (one visible in FIG. 7). The grooves 213 are formed on the outer wall of the tubular element 15, i.e. on the opposite wall with respect to that facing the light guide 4. In a non-limiting embodiment, the grooves 213 are made for the entire length of the tubular element 15 along the axis A.

The protrusion-groove coupling therefore prevents the support element 205 from rotating when the helicoidal element 206 is rotated by the actuator 207: in fact, the protrusions 212 constrain the support element 205 to slide only along the axis A. In this way, the helicoidal element 206 can push (upwards in FIG. 7) and pull (downwards in FIG. 7) the support element 205 and therefore the diffuser 201. In other words, the helicoidal element 206 acts as a screw and the support element 205 as a nut of the drive mechanism 204.

More generally, the tubular element 15 of the drive mechanism 204 described above is a shaft extending along the axis A provided with the axial grooves 213. The support element 205 is configured to be movable (along the axis A) with respect to the shaft and the helicoidal element 206 extends along the axis A around the shaft. The shaft is for example a hollow body surrounding the tubular element 15 supporting the light guide 4, for example the shaft supports the tubular element 15 and acts as a mechanical interface with the housing 2. Preferably, the shaft coincides with the tubular element 15 itself.

As can be seen in FIGS. 6A-6C, the central aperture 16 of the secondary reflector 6 is shaped to allow the translational movements of the support element 205 of the drive mechanism 204. In detail, the central aperture 16 is such as to allow, without mechanical interference, the movements of the support element 205 between the end stop defined by the first operating position of the diffuser 201 and the end stop defined by the second operating position of the diffuser 201. More generally, the central aperture 16 of the secondary reflector 6 is shaped to allow the passage of at least a portion of the diffuser 201.

The actuator 207 comprises in detail a motor 214, a transmission belt 215, and a pulley 216 coupled to the helicoidal element 206. The transmission belt 215 transmits the movement generated by the motor 214 to the pulley 216 and the helicoidal element 206 can thus be made to rotate. In a non-limiting embodiment, the motor 214 is a stepper motor, the pulley 216 is connected to the helicoidal element 206 at a lower end of the helicoidal element 206, and moreover the pulley 216 is shaped to also surround the tubular element 15 of the light guide 4. In an alternative embodiment, the transmission of the rotation between the motor 214 and the helicoidal element 206 is conducted by means of a gear system.

Preferably, the actuator 207 is positioned in the lighting device 200 rearward of the secondary reflector 6 with respect to the projection outlet 9. The motor 214 can also be controlled by the same control unit or control console of the lighting device 200 that controls the primary light source group 3.

The lighting device 200 therefore makes it possible to obtain the scenic effect of a diffusion of the primary light beam adjustable between a minimum and a maximum according to the stage needs and specific applications. The diffusive effect is visible both along the propagation of the primary light beam emitted by the lighting device 200 and on a projection, for example on a wall, of the primary light beam. Moreover, a further scenic effect obtained with the lighting device 200 is that of creating the optical illusion (for an external observer looking towards the lighting device 200) that the secondary reflector 6, on which the diffuser 201 can reflect, is the light source itself of the lighting device 200.

The drive mechanism 204 of the lighting device 200 implements an extremely precise movement of the diffuser 201 between an operating position of disengagement and an operating position of complete insertion into the optical path of the primary light beam. More particularly, the gradual insertion of the diffuser 201 allows for a progressive and totally user-controllable diffusive effect. The controllable diffusion is especially useful in multi-colour light beam projection applications where a controllable mixing effect is desirable. Moreover, the drive mechanism 204 allows for a total exclusion of the diffuser 201 when not in use, without mechanical interference and without introducing losses in light efficiency. Finally, the diffuser 201 and the drive mechanism 204, being positioned inside the lighting device 200, are protected from the external environment.

More generally, the diffuser 201 described above is a generic optical element of a substantially truncated-cone shape, movable to selectively apply an optical action to the primary light beam reflected by the primary reflector 5; the optical element is movable with respect to the light guide 4 and along the axis A between the first operating position and the second operating position. In detail, said optical element may have optical properties different from the diffusive one described, i.e. the optical action applied by the optical element may be different from the diffusive action of the diffuser 201. The optical element is for example a dichroic filter—for example comprising one or more lateral sectors with different colours—configured to impart a specific colour to a white primary light beam, in its progressive insertion into the optical path between the primary reflector 5 and the secondary reflector 6. The optical element may alternatively be a prismatic-face element (i.e., an element comprising one or more lateral sectors each having a plurality of faces, for example two) whose progressive insertion produces a gradual modification of the propagation angle of the primary light beam. Preferably, the optical element coincides with the diffuser 201 itself.

In a non-limiting embodiment, a further drive mechanism (not shown), additional to the drive mechanism 204, also allows rotations of the optical element around the axis A: for example, the rotation of the optical element is preferable in the case where the optical element is a dichroic filter having lateral sectors with different colourations or a prismatic-face element. For example, such a further drive mechanism comprises a further motor, a further transmission belt and a further pulley for example coupled to (or incorporated in) a lower base of the shaft that supports the tubular element 15: the further motor—which can be driven synchronously with the motor 214—and the further pulley transmit a rotation to the shaft, the shaft (and therefore the support element 205 coupled to it by means of the protrusion-groove coupling) thus being able to rotate—around the axis A and in both directions—with respect to the tubular element 15; the support element 205 can therefore be rotated independently of the translational movement along the axis A.

It is understood that the technical teachings of the lighting device 1 of FIGS. 1-3, of the lighting device 100 of FIGS. 4 and 5 and of the lighting device 200 of FIGS. 6A-6C and FIGS. 7 and 8 are mutually combinable, and consequently the respective scenic effects are also combinable. For example, it is possible to obtain a lighting device with a movable diffuser as described above which also comprises the secondary light source group integrated into the primary reflector; to such a variant it is possible to add the implementation of the relative movement between the primary reflector and the secondary reflector to also obtain an annular illumination with variable projection angles.

Finally, it is clear that modifications and variations may be made to what has been described and illustrated herein without thereby departing from the scope of the present invention, as defined in the appended claims.

For example, at least one of the first mirror and the second mirror may have curvatures other than spherical. For example, at least one of the first mirror and the second mirror may have respective portions in which the radius of curvature is not constant. For example, at least one of the first mirror and the second mirror may comprise portions with a hyperbolic and/or aspherical profile (for example, of even order and of degree equal to or greater than the fourth). In a further variant, the entire reflecting surface of at least one of the first mirror and the second mirror has a hyperbolic and/or aspherical profile.

What is claimed is:

1. A lighting device (1; 100; 200) comprising:
a primary light source group (3), configured to emit a primary light beam;
a light guide (4), extending along a longitudinal axis (A) and coupled to the primary light source group (3) so as to define a defined optical path for at least a part of the primary light beam;
a primary reflector (5), arranged along the axis (A) facing the primary light source group (3), to reflect the primary light beam output from the light guide (4); and
a secondary reflector (6), arranged facing the primary reflector (5), to reflect the primary light beam reflected by the primary reflector (5) towards an emission area surrounding the primary reflector (5),
wherein the primary reflector (5) comprises a convex first mirror (14) and the secondary reflector (6) comprises a concave second mirror (17), and
wherein the secondary reflector (6) is provided with a central aperture (16) engaged, in use, by the light guide (4).

2. The lighting device (1; 100; 200) according to claim 1, wherein at least one between the light guide (4), the primary reflector (5) and the secondary reflector (6) is movable along the axis (A) so as to vary the angular distribution of the primary light beam reflected by the secondary reflector (6).

3. The lighting device (1; 100; 200) according to claim 1 wherein the light guide (4) is an optical mixing tube provided with an input (10), coupled to the primary light source group (3), and with an output (11), facing the primary reflector (5).

4. The lighting device (100) according to claim 1, further comprising a secondary light source group (101), configured to emit at least one secondary light beam, wherein the secondary light source group (101) is integrated into the primary reflector (5) and is arranged so as that at least a part of the at least one secondary light beam emitted by the secondary light source group (101) is reflected by the secondary reflector (6).

5. The lighting device (100) according to claim 4, wherein the primary reflector (5) comprises a support body (13) configured to support the first mirror (14) and the secondary light source group (101), wherein the support body (13) comprises a face facing the primary light source group (3) and coupled to the first mirror (14), and an outer edge surrounding said face, the secondary light source group (101) being arranged along said outer edge.

6. The lighting device (100) according to claim 4, wherein the secondary light source group (101) comprises a plurality of secondary light sources (102) arranged aligned along a substantially circular path around the first mirror (14), each secondary light source (102) being oriented so as to emit at least a part of a respective secondary light beam towards the secondary reflector (6).

7. The lighting device (100) according to claim 4, further comprising a control device configured to independently control the primary light source group (3) and the secondary light source group (101).

8. The lighting device (200) according to claim 1, further comprising an optical element (201), of substantially truncated-cone shape, optically interposed between the primary reflector (5) and the secondary reflector (6) and extending along the axis (A).

9. The lighting device (200) according to claim 8, wherein the optical element (201) is shaped so as to be placed around the light guide (4), and wherein the larger end (202) of the optical element (201) faces the primary reflector (5).

10. The lighting device (200) according to claim 9, wherein the optical element (201) is internally hollow.

11. The lighting device (200) according to claim 8, wherein the optical element (201) is movable to selectively apply an optical action to the primary light beam reflected by the primary reflector (5).

12. The lighting device (200) according to claim 8, further comprising a drive mechanism (204) of the optical element (201) configured to move the optical element (201), with respect to the light guide (4) and along the axis (A), between a first operating position and a second operating position,
wherein in the first operating position the larger end (202) of the optical element (201) is distal from the primary reflector (5), and
wherein in the second operating position the larger end (202) of the optical element (201) is proximal to the primary reflector (5).

13. The lighting device (200) according to claim 12, wherein the optical element (201) comprises a diffuser (201), the optical element (201) being configured to apply a diffusive action to the primary light beam reflected by the primary reflector (5),
wherein in the first operating position the diffusive action is minimal, and wherein in the second operating position the diffusive action is maximum.

14. The lighting device (200) according to claim 12, wherein the drive mechanism (204) is of the endless screw type and is configured so as to prevent the rotation of the optical element (201) during the movement along the axis (A).

15. The lighting device (200) according to claim 12, wherein the drive mechanism (204) comprises:
a shaft (15);
a support element (205), coupled to the optical element (201) and configured to be movable with respect to the shaft (15);
a helicoidal element (206), cooperating with the support element (205) and extending along the axis (A) around the shaft (15); and
an actuator (207), configured to rotate the helicoidal element (206),
wherein the helicoidal element (206) cooperates with the support element (205) so as that rotations of the helicoidal element (206) around the axis (A) correspond to translations of the support element (205) along the axis (A) in order to move the optical element (201) between the first operating position and the second operating position.

16. The lighting device (200) according to claim 15, wherein the shaft (15) is provided with axial grooves (213), and wherein the support element (205) has a substantially annular shape so as to surround the shaft (15) and comprises protrusions (212) which engage corresponding grooves (213) of the shaft (15), the protrusions (212) being axially offset.

17. The lighting device (200) according to claim 12, further comprising a further drive mechanism configured so as to allow rotations of the optical element (201) around the axis (A).

18. The lighting device (200) according to claim 17, wherein the optical element (201) comprises a prismatic-face element or a dichroic filter.

19. The lighting device (200) according to claim 11, wherein the central aperture (16) of the secondary reflector (6) is shaped so as to allow the passage of at least a portion of the optical element (201).

20. A stage light fixture comprising one or more lighting devices (1; 100; 200), each lighting device (1; 100; 200) being realized according to claim 1.
